(19) United States
(12) Patent Application Publication
(10) Pub. No.: US 2021/0242648 A1
(43) Pub. Date: Aug. 5, 2021

(54) RAPID PHASE RETRIEVAL BY LASING

(71) Applicant: YEDA RESEARCH AND DEVELOPMENT CO. LTD., Rehovot (IL)

(72) Inventors: Nir DAVIDSON, Rehovot (IL); Asher FRIESEM, Rehovot (IL); Oren RAZ, Rehovot (IL); Chene TRADONSKY, Rehovot (IL)

(73) Assignee: YEDA RESEARCH AND DEVELOPMENT CO. LTD., Rehovot (IL)

(21) Appl. No.: 17/048,711

(22) PCT Filed: Apr. 29, 2019
(86) PCT No.: PCT/IL2019/050473

§ 371 Date: Oct. 19, 2020

Related U.S. Application Data
(60) Provisional application No. 62/664,561, filed on Apr. 30, 2018.

(51) Int. Cl. H01S 3/00; H01S 3/06; H01S 3/08; H01S 3/083; H01S 3/105; H01S 3/106; H01S 3/10

(52) U.S. Cl. CPC H01S 3/0007; H01S 3/061; H01S 3/0805; H01S 3/1611; H01S 3/105; H01S 3/106; H01S 3/10061; H01S 3/083

(57) ABSTRACT

Laser systems and methods configured to reconstruct an image of an object from an input comprising: the objects scattered intensity distribution (SID) and the objects compact support; the system comprising: a first lens and a second lens, in a four-focal telescope configuration; a gain with a minor at one end, at first end of the telescope, configured to amplify and reflect a received beam; a reflective spatial light modulator, at second end of the telescope, configured to selectively reflect intensity distributions of a received beam, according to their spatial location, the selective reflection is configured to maintain the intensity distributions of the objects SID; a spatial intensity binary mask, located between the telescope's lenses, comprising an aperture in the form of the objects compact support; the mask is configured to transfer only beams passing through the aperture. The reconstructed objects image is provided at least at the mask's aperture.

### BACKGROUND OF THE INVENTION

Calculating the intensity distribution of light scattered from an object is relatively easy, it is the square of the absolute value of the object's Fourier transform [Goodman, J. W. Introduction to Fourier optics. (Roberts and Company Publishers, 2005)]. However, reconstructing an object from its scattered intensity distribution is generally an ill-posed problem because the phase information is lost, and different choices of phase distributions result in different reconstructions.

Accordingly, there is a need for a new system and method that can solve phase retrieval problems rapidly.

### SUMMARY OF THE INVENTION

In some embodiments of the invention a laser system is provided configured to reconstruct an image of an object from an input comprising: the object's scattered intensity distribution (SID) and the object's compact support; the system comprising:
a first lens and a second lens, in a four-focal telescope configuration;
a gain with a mirror at one end, at first end of the telescope, configured to amplify and reflect a received beam;
a reflective spatial light modulator (SLM), at second end of the telescope, configured to selectively reflect intensity distributions of a received beam, according to their spatial location, wherein the selective reflection is configured to maintain the intensity distributions of the object's SID;
a spatial intensity binary mask, located between the telescope's lenses, comprising an aperture in the form of the object's compact support; the mask is configured to transfer only beams passing through the aperture;
wherein the reconstructed object's image is provided at least at the mask's aperture.

According to some embodiments, at least one of the following holds true:
the gain is positioned at one first focal length (f1) in front of the first lens;
the SLM is positioned at one second focal length (f2) behind the second lens;
the mask is positioned at one first focal length (f1) behind of the first lens, and one second focal length (f2) in front of the second lens;
the gain's mirror is a partial mirror, configured to output a fraction of the gain's reflected image;
further comprising a camera, configured to photocopy and display the reconstructed image.

According to some embodiments, the object's SID comprises Furrier magnitudes of the object's scattered light.

According to some embodiments, the SLM comprises an array of pixels, each pixel's reflectance is controlled independently, optionally via a computer.

According to some embodiments, reflectance of each pixel is according to:

$${T}_{S L M} ( \vec{k} ) = exp ( \frac{{g}_{0}}{1 + {\vert {E}_{s o l} ( \vec{k} ) \vert}^{2} / {I}_{sat}} ) = exp ( \frac{{g}_{0}}{1 + {I}_{S I D} ( \vec{k} ) / {I}_{sat}} )$$

where:
T_{SLM}(\vec{k}) is a linear transformation that represents the amplitude transmittances at the SLM;
\vec{k} is the position at the SLM plane;
Iₛₐₜ is the saturation intensity;
g₀ is the linear gain at very low intensities, set by a pumping strength;
E(\vec{k}) is an electric field on the SLM;
I_{SID}(\vec{k})=|Eₛₒₗ(\vec{k})|² is the scattered intensity distribution on the SLM.

According to some embodiments, the object's SID and the object's reconstructed image comprise data from a field selected from: astronomy, X-ray, crystallography, imaging though turbid media, short pulse characterization, speech processing, encryption and decryption, ptychographic imaging, lens-less photography and microscopy, NMR, and synthetic aperture radar.

In some embodiments of the invention a method is provided for reconstructing an image of an object from an input comprising: the object's scattered intensity distribution (SID) and the object's compact support, using the laser system of any of the above mentioned system embodiments; the method comprising:
spontaneously lasing multiple transverse mode beams, via the gain;
iteratively reflecting the lasing beams between the gain and the SLM via the mask, while decaying lasing modes which do not comply with the object's SID and the objects compact support, until only beams with one lasing mode and optionally its conjugating lasing mode are left, thereby the one (or two) mode is most probable as an origin mode;
providing the object's reconstructed image at least at the mask's aperture, based on the most probable mode/s.

According to some embodiments, at least one of the following holds true:
the method further comprising retrieving phase of the most probable lasing mode;
the method further comprising monitoring the gain's reflected images via an output coupler;
the method further comprising displaying the reconstructed image via a camera.

In some embodiments of the invention a laser ring system is provided configured to reconstruct an image of an object from an input comprising: the object's scattered intensity distribution (SID) and the object's compact support; the system comprising:
two first lenses, one or two second lenses, and at least four beam folding elements, all arranged in a ring configuration of a first- and a second-four-focal telescopes;
a gain medium, at a first tangent point of the two telescopes, configured to amplify and lase forward beams received from the second telescope towards the first telescope;
a transmissive spatial light modulator (SLM), at a second tangent point of the two telescopes, configured to selectively lase forward intensity distribution of beams received from the first telescope towards the second telescope, according to their spatial location, wherein the selective lasing is configured to maintain the intensity distributions of the object's SID; or a reflective spatial light modulator (SLM), at a second tangent point of the two telescopes, configured to selectively reflect intensity distribution of beams received from the first telescope towards the second telescope, according to their spatial location, wherein the selective reflecting is configured to maintain the intensity distributions of the object's SID;
a spatial intensity binary mask, located between the lenses of the second telescope comprising an aperture in the form of the object's compact support;

wherein the reconstructed object's image is provided at least at the mask's aperture.

According to some embodiments, the object's SID comprises Furrier magnitudes of the object's scattered light.

According to some embodiments, the transmissive or reflective SLM comprises an array of pixels, each pixel's transmittance or reflectance is controlled independently, optionally via a computer.

According to some embodiments, transmittance or reflectance of each pixel is according to:

$${T}_{S L M} ( \vec{k} ) = exp ( \frac{{g}_{0}}{1 + {\vert {E}_{s o l} ( \vec{k} ) \vert}^{2} / {I}_{sat}} ) = exp ( \frac{{g}_{0}}{1 + {I}_{S I D} ( \vec{k} ) / {I}_{sat}} )$$

where:
T_{SLM}(\vec{k}) is a linear transformation that represents the amplitude transmittances at the SLM;
\vec{k} is the position at the SLM plane;
Iₛₐₜ is the saturation intensity;
g₀ is the linear gain at very low intensities, set by a pumping strength;
E(\vec{k}) is an electric field on the SLM;
I_{SID}(\vec{k})=|Eₛₒₗ(\vec{k})|² is the scattered intensity distribution on the SLM.

According to some embodiments, the object's SID and the object's reconstructed image comprise data from a field selected from: astronomy, X-ray, crystallography, imaging though turbid media, short pulse characterization, speech processing, encryption and decryption, ptychographic imaging, lens-less photography and microscopy, NMR, and synthetic aperture radar.

According to some embodiments, the system comprises a single second lens, at least six beam folding elements, and a first polarization beam splitter (PBS1); all arranged in a ring configuration of a first- and a second-four-focal telescopes, and wherein the second lens serves for both telescopes via the first PBS1 and wherein the SLM is reflective.

According to some embodiments, the ring system further comprises at least one of: a Faraday rotator and at least one half wave plate, configured to rotate their passing beams, such that they enable the first PBS1 to pass through beams of the first telescope path and to reflect and redirect beams of the second telescope.

According to some embodiments, the ring system further comprises a second beam splitter (PBS2), which is located between the second lens and the reflective SLM, configured to redirect a small part of its received beam, for monitoring and/or imaging purposes, while the substantial part of the beam continues its original path.

According to some embodiments, the ring system further comprises a camera and optimally at least one lens, configured to photocopy and/or display the reconstructed image provided by the second PBS2.

In some embodiments of the invention a method is provided for reconstructing an image of an object from an input comprising: the object's scattered intensity distribution (SID) and the object's compact support, using the laser ring system of any of the above mentioned embodiments; the method comprising:
spontaneously lasing multiple transverse mode beams, via the gain;
iteratively lasing the beams between the gain and the SLM via the mask, while decaying lasing modes which do not comply with the object's SID and the objects compact support, until only beams with one lasing mode and optionally its conjugating lasing mode are left, thereby the one (or two) mode is most probable as an origin mode;
providing the object's reconstructed image at least at the mask's aperture, based on the most probable mode/s.

According to some embodiments, at least one of the following holds true:
the method further comprising retrieving phase of the most probable lasing mode;
the method further comprising monitoring the gain's reflected images via an output coupler;
the method further comprising displaying the reconstructed image via a camera.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically demonstrates a prior art solution for a phase retrieval problem;

FIG. 2 schematically demonstrates a linear digital degenerate cavity laser (DDCL) system, according to some embodiments of the invention;

FIG. 3 schematically demonstrates a ring digital degenerate cavity laser system (DDCL), according to some embodiments of the invention;

FIG. 4 schematically demonstrates another ring digital degenerate cavity laser (DDCL) system, according to some embodiments of the invention;

FIGS. 5A-5E schematically demonstrate a simplified experimental arrangement of a ring DDCL, according to some embodiments of the invention;

FIG. 6A-6D schematically demonstrate a Q-switched linear DCL system (FIG. 6A), the results at quasi-CW lasing (FIGS. 6B and 6C) and the results at Q-switched lasing operation with pulse duration of 100 ns (FIGS. 6D and 6E), according to some embodiments of the invention;

FIG. 7A-7I, schematically demonstrate the results for the reconstruction of three different centrosymmetric objects, with uniform phase distribution and a circular compact support, according to some embodiments of the invention;

FIG. 8A-8L, schematically demonstrate the reconstruction of four similar objects, each with a different phase distribution and therefore different scattered intensity distribution, according to some embodiments of the invention;

FIGS. 9A-9H, schematically demonstrate representative experimental results for an investigation of the effect of tightness and symmetry of the compact support on the reconstruction quality, according to some embodiments of the invention;

FIGS. 10A-10C, schematically demonstrate an image of the actual scattering object (FIG. 10A), its simulated intensity distribution of the diffraction pattern inside the cavity (FIG. 10B) and the reconstructed intensity distribution of the object after 100 iterations inside the laser cavity (FIG. 10C), according to some embodiments of the invention;

FIGS. 11A-11L schematically demonstrate quantitative experimental results for the effect of object complexity on the reconstruction fidelity;

FIGS. 12A-12B schematically demonstrate quantitative experimental values for the effect of object complexity on the reconstruction fidelity; and

FIG. 13 schematically demonstrates quantitative effect of tightness of the size of the compact support on the reconstruction quality and fidelity.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Embodiments of the present invention disclose and experimentally demonstrate novel all-optical systems and methods that solve phase retrieval problems rapidly, by reconstructing an object's image from its scattered intensity distribution and its compact support.

As used herein, in one embodiment the term “about” refers to ±10%. In another embodiment, the term “about” refers to ±9%. In another embodiment, the term “about” refers to ±9%. In another embodiment, the term “about” refers to ±8%. In another embodiment, the term “about” refers to ±7%. In another embodiment, the term “about” refers to ±6%. In another embodiment, the term “about” refers to ±5%. In another embodiment, the term “about” refers to ±4%. In another embodiment, the term “about” refers to ±3%. In another embodiment, the term “about” refers to ±2%. In another embodiment, the term “about” refers to ±1%.

A skilled artisan would appreciate that, a spatial light modulator (SLM), may refer to, according to some embodiments, a device that imposes a form of spatially varying phase and/or intensity modulation on a beam of light.

A skilled artisan would appreciate that, a gain or gain medium, may refer to, according to some embodiments, a device comprising a medium that transfers part of its energy to an emitted electromagnetic radiation, for example by coherent amplification of the electromagnetic field passing through it, resulting in an increase in its optical intensity.

A skilled artisan would appreciate that, a Faraday rotator, may refer to, according to some embodiments, a polarization rotator based on the Faraday effect, based on a magneto-optic effect.

A skilled artisan would appreciate that, waveplate, may refer to, according to some embodiments, an optical device that alters the polarization state of a light wave travelling through it. According to some embodiments, two types of waveplates are used: the half-wave plate, which shifts the polarization direction of linearly polarized light, and the quarter-wave plate, which converts linearly polarized light into circularly polarized light and vice versa.

A skilled artisan would appreciate that, a polarizer may refer to, according to some embodiments, an optical filter that lets light waves of a specific polarization pass through, while blocking or reflecting light waves of other polarizations.

A skilled artisan would appreciate that, an output coupler (OC) may refer to, according to some embodiments, a component of an optical cavity that allows the extraction of a portion of the light from a laser's intracavity beam.

A skilled artisan would appreciate that, optical cavity may refer to, according to some embodiments, to an arrangement of mirrors or other reflectors that forms a standing wave cavity resonator for light waves; according to some embodiments, the cavity may be arranged as a ring for said light waves. Optical cavities are a major component of lasers, surrounding the gain medium and providing feedback of the laser light. Light confined in the cavity reflects multiple times producing standing waves for certain resonance frequencies. The standing wave patterns produced are called modes; longitudinal modes differ only in frequency, while transverse modes have different intensity patterns across the cross section of the beam.

A skilled artisan would appreciate that, the compact support of an object may refer to, according to some embodiments, the object's boundaries outline or boundaries shape.

A skilled artisan would appreciate that, Q-switching or Q-switch, also known as giant pulse formation or Q-spoiling, may refer to according to some embodiments, a technique by which a laser is made to produce a pulsed output beam. The technique allows the production of light pulses with extremely high (gigawatt) peak power, much higher than would be produced by the same laser if it were operating in a continuous wave (constant output) mode.

In many applications an additional prior information, e.g. the object's shape, positivity, spatial symmetry and sparsity, can be exploited to remove most of extraneous phases and hence enable object reconstruction. Applications such as:
astronomy [Fienup, J. C. & Dainty, R. J. Phase retrieval and image reconstruction for astronomy. in Image recovery: theory and application (ed. Stark, H.) 231-275 (1987)],
short pulses characterization [Raz, O. et al. Vectorial phase retrieval for linear characterization of attosecond pulses. Phys. Rev. Lett. 107, 1-5 (2010],
X-ray diffraction [Seibert, M. M. et al. Single mimivirus particles intercepted and imaged with an X-ray laser. Nature 470, 78-81 (2011)] and [Millane, R. P. Phase retrieval in crystallography and optics. J. Opt. Soc. Am. A 7, 394 (1990)],
radar detection [Lombardini, F. Absolute Phase Retrieval in a Three-Element Synthetic Aperture Radar Interferometer. IEEE Int. Geosci. Remote Sens. Symp. 309-312 (1994). doi:10.1109/ICR.1996.574449],
speech recognition [Balan, R., Casazza, P. & Edidin, D. On signal reconstruction without phase. Appl. Comput. Harmon. Anal. 20, 345-356 (2006)],
and imaging through turbid media [Bertolotti, J. et al. Non-invasive imaging through opaque scattering layers. Nature 491, 232-234 (2012)] and [Katz, O., Heidmann, P., Fink, M. & Gigan, S. Non-invasive real-time imaging through scattering layers and around corners via speckle correlations. Nat. Photonics 8, 784-790 (2014)].

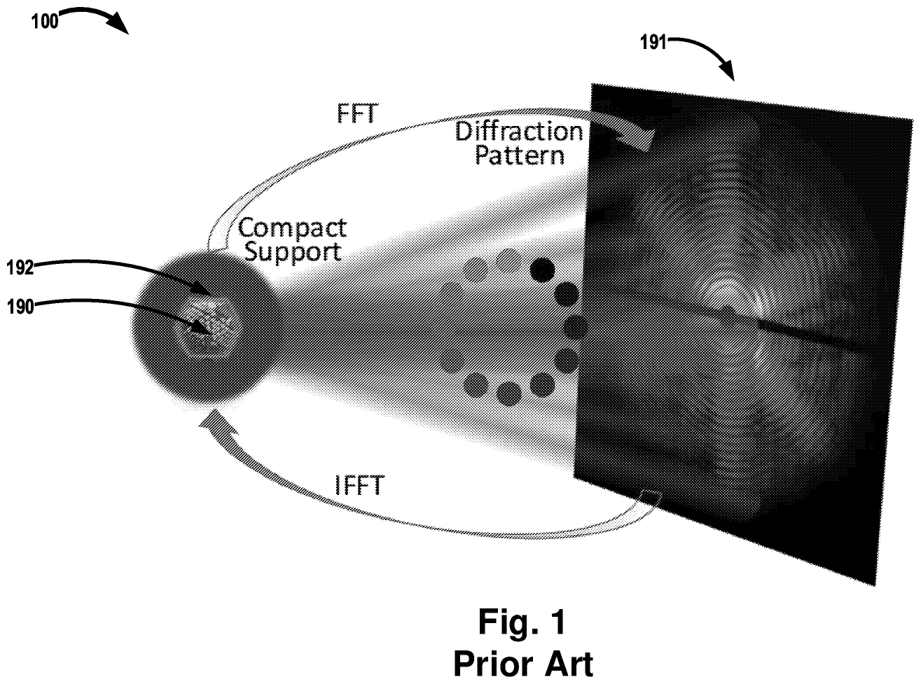

Reference is now made to FIG. 1, which schematically demonstrates a prior art solution 100 to the phase retrieval problem. For objects 190 with a finite extent (compact support, which includes the outer boundaries of the object) 192, a unique solution to the phase retrieval problem almost always exists (up to some trivial ambiguities), provided that the scattered intensity 191 is sampled at a sufficiently high resolution [Bruck, Y. M. & Sodin, L. G. On the ambiguity of the image reconstruction problem. Opt. Commun. 30, 304-308 (1979)].

Several algorithms for solving this phase retrieval problem were developed including:
the Gerchberg-Saxton (GS) error reduction algorithm [Gerchberg, R. A practical algorithm for the determination of phase from image and diffraction plane pictures. Optik (Stuttg). 35, 237-246 (1972)];
hybrid input-output (HIO) algorithm [Fienup, J. R. R. Reconstruction of an object from the modulus of its Fourier transform. Opt. Lett. 3, 27-29 (1978)];
relaxed averaged alternating reflections (RAAR) algorithm [Luke, D. R. Relaxed averaged alternating reflections for diffraction imaging. Inverse Probl. 21, 37-50 (2005)];
difference map algorithm [Elser, V. Phase retrieval by iterated projections. J. Opt. Soc. Am. A 20, 40 (2003)]; and
shrink-wrap algorithm [Marchesini, S. et al. X-ray image reconstruction from a diffraction pattern alone. 1-4 (2003). doi:10.1103/PhysRevB.0.68.140101] (and for modern review [Chapman, H. N. & Nugent, K. a. Coherent lensless X-ray imaging. Nat. Photonics 4, 833-839 (2010)],[Marchesini, S. A unified evaluation of iterative projection algorithms for phase retrieval. Rev. Sci. Instrum. 78, (2007)] and [Shechtman, Y. et al. Phase Retrieval with Application to Optical Imaging: A contemporary overview. IEEE Signal Process. Mag. 32, 87-109 (2015)].
Unfortunately, these algorithms are based on iterative projections process and hence are relatively slow, even with high performance computers [Shechtman, Y. et al.] and [Candès, E. J., Eldar, Y., Strohmer, T. & Voroninski, V. Phase Retrieval via Matrix Completion. Electr. Eng. abs/1109.0, 1-2 (2011)].

In several computational challenges, specifically tailored physical systems could be more efficient in solving a problem than conventional silicon based computers. These systems are not universal Turing machine, namely they cannot perform any calculation as a standard computer, but they can solve a class of specific problems.

The most prominent examples for such systems are the D-Wave machine that can find through quantum annealing the ground state of a complicated Hamiltonian [Dickson, N. G. et al. Thermally assisted quantum annealing of a 16-qubit problem. Nat. Commun. 4, 1903 (2013)], [Boixo, S., Albash, T., Spedalieri, F. M., Chancellor, N. & Lidar, D. A. Experimental signature of programmable quantum annealing. Nat. Commun. 4, 1-12 (2013)] and [Boixo, S. et al. Evidence for quantum annealing with more than one hundred qubits. Nat. Phys. 10, 218-224 (2014)], and coupled lasers and optical parametric oscillators (OPO) systems that can solve various difficult optimization problems [Nixon, M. et al. Real-time wavefront shaping through scattering media by all-optical feedback. Nat. Photonics 7, 919-924 (2013)], [Nixon, M., Ronen, E., Friesem, A. A. & Davidson, N. Observing Geometric Frustration with Thousands of Coupled Lasers. Phys. Rev. Lett. 110, 184102 (2013)], [Inagaki, T. et al. Large-scale Ising spin network based on degenerate optical parametric oscillators. Nat. Photonics 10, 415-+(2016)] and [Marandi, A., Wang, Z., Takata, K., Byer, R. L. & Yamamoto, Y. Network of time-multiplexed optical parametric oscillators as a coherent Ising machine. Nat. Photonics 8, 937-942 (2014)]. Solving hard problems, including phase retrieval and other non-convex optimization, with such systems offer significant advantage in terms of computation time and resources over conventional computers.

Embodiments of the present invention disclose and experimentally demonstrate novel all-optical systems and methods that solve phase retrieval problems rapidly. According to some embodiments, the systems comprise a digital degenerate cavity laser (DDCL), into which both the Fourier magnitudes of the scattered light from the originally imaged object and the compact support of the object constraints are incorporated such that the nonlinear lasing process results in a self-consistent solution that satisfies both constraints (maintain the Fourier magnitudes of the scattered light, while masking the lasing beam via the compact support).

According to some embodiments, the nonlinear lasing process is provided with a time limit. In some embodiments an upper bound of 100 nano-seconds is provided. According some embodiments and as demonstrated in the following experiments, the nonlinear lasing process converges at the DDCL system to a stable solution, within said 100 nano-seconds.

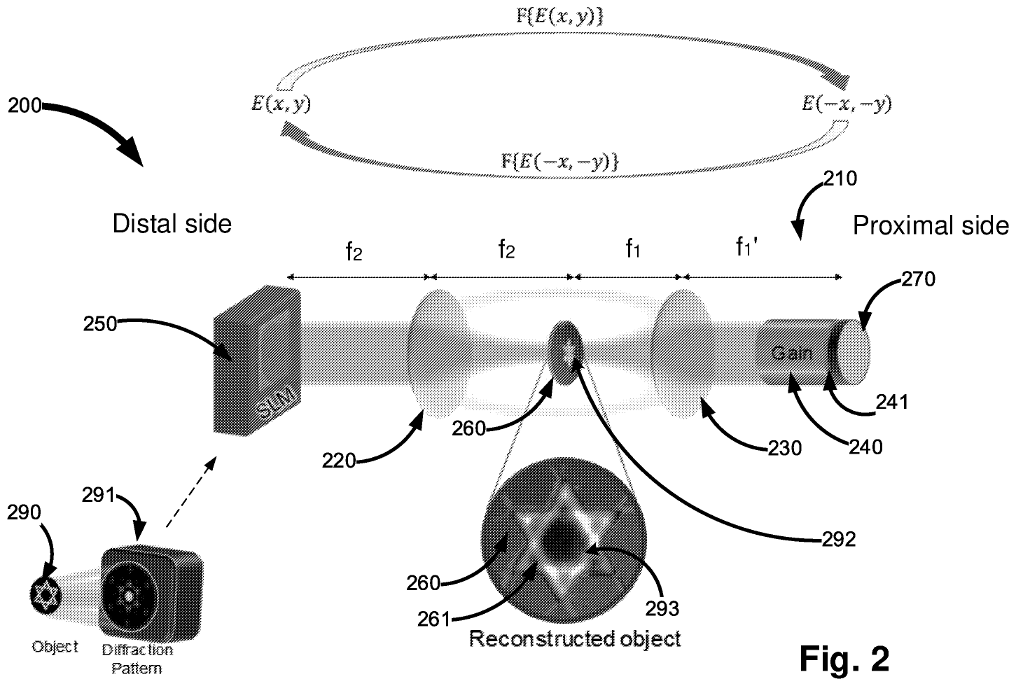

Reference is now made to FIG. 2, which schematically demonstrates the basic linear digital degenerate cavity laser (DDCL) system 200, according to some embodiments of the invention. The laser system 200 is configured to reconstruct an image of an object 290 from an input comprising: the object's scattered intensity distribution (SID) 291 and the object's compact support 292 (the outer boundaries of the object). The system comprising:
a first lens 220 and a second lens 230, in a four-focal telescope configuration 210;
a gain 240 with a mirror 241 at its proximal end, the gain located at proximal end of the telescope, configured to amplify and reflect a received beam;
a reflective spatial light modulator (SLM) 250, at distal end of the telescope, configured to selectively reflect intensity distributions of a received beam, according to their spatial location, wherein the selective reflection is configured to maintain the intensity distributions of the object's SID;
a spatial intensity binary mask 260, located between the telescope's lenses, comprising an aperture 261 in the form of the object's compact support; the mask is configured to transfer only beams passing through the aperture;

wherein the reconstructed object's image 293 is provided at least at the mask's aperture.

According to some embodiments, the gain's mirror is a partial mirror, configured as an output coupler 270 to reflect a substantial part of a received beam, and transfer the rest of the beam for monitoring and/or imaging purposes.

According to some embodiments, the system further comprising an imaging system comprising an output coupler 270 and a third lens or more (not shown), configured to provide the reconstructed image. According to some embodiments, the imaging system may be located anywhere along the beam in order to image the reconstructed object; for example, at the mask's aperture.

According to some embodiments, the ratio between the focal of the first lens f₁ and the focal of the second lens f₂ equals to the diameter ratio of the gain vs. the SLM.

$$\frac{{d}_{SLM}}{{d}_{gain}} = \frac{{f}_{2}}{{f}_{1}} = M \qquad Eq . ( 1 )$$

Where: d_{SLM} is the SLM clear aperture diameter,
d_{gain} is the gain clear aperture diameter,
f₁ and f₂ are the focal distance of the first and second lenses, and
M is the telescope magnification ratio.

According to some embodiments, the outer diameter of the compact support mask (CSM) d_{CSM} is proportional to the focal distance of the second lens f₂: d_{CSM}∝f₂.

According to some embodiments, the gain is configured to spontaneously start multi-mode beams emission.

According to some embodiments, the SLM is configured to scatter the non-reflected intensity distributions of the received beam/s.

According to some embodiments, the mask is configured to scatter or absorb, beams or beams fractions, which are not transferred via its aperture.

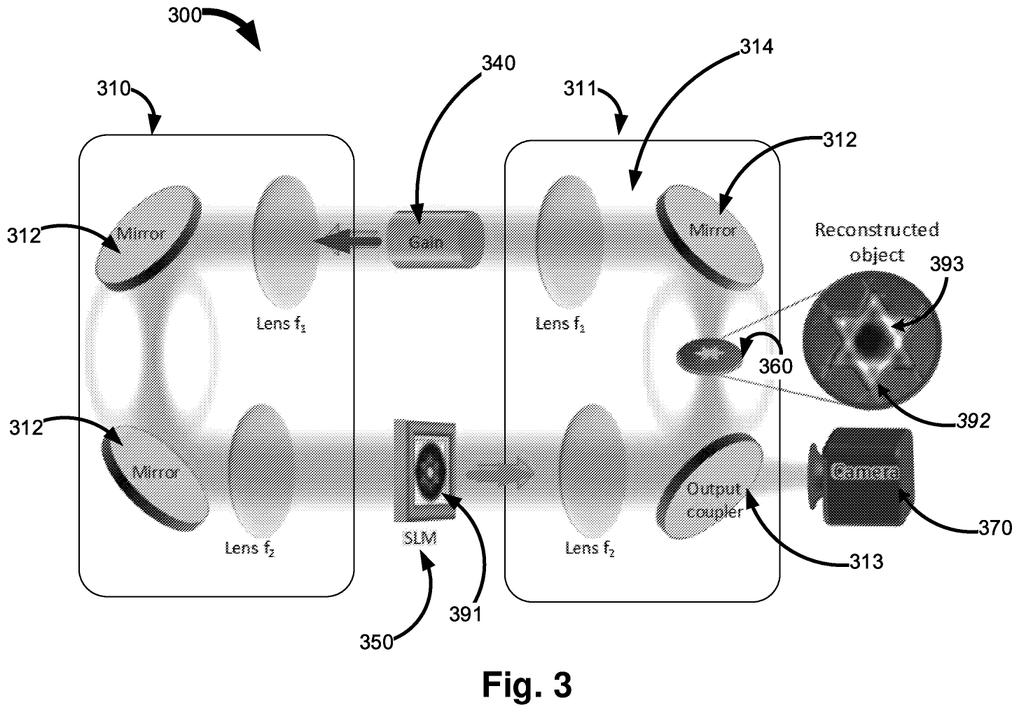

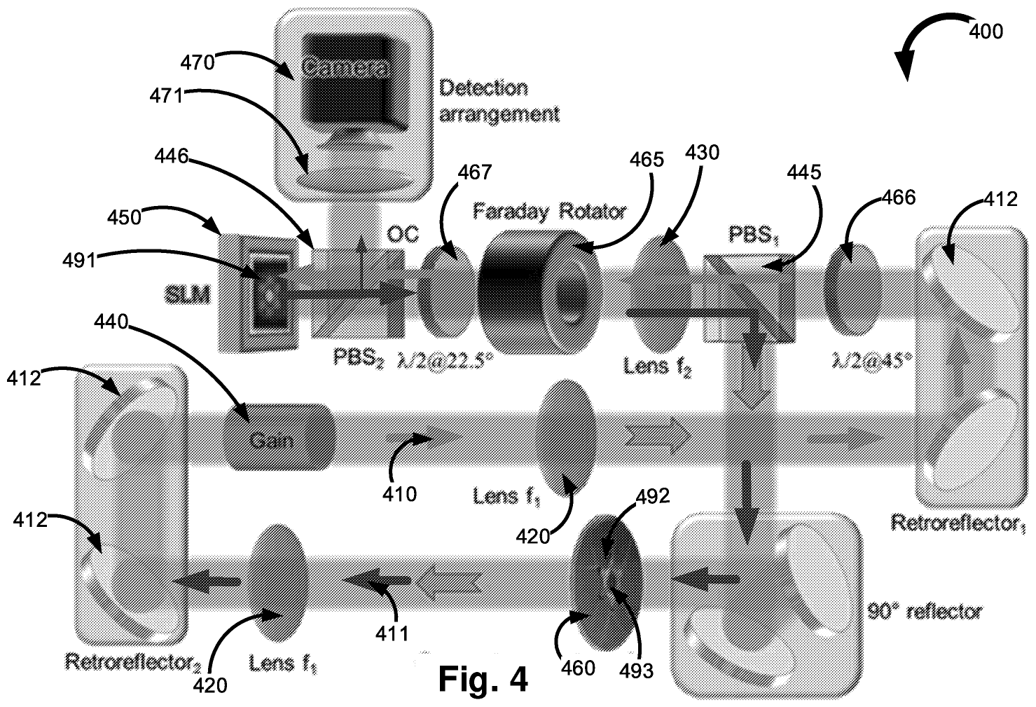

According to some embodiments, the mask's aperture contains no reflecting matter. According to some embodiments, the reconstructed image is provided by other methods, for example and as demonstrated in FIG. 2 via the gain's partial mirror. More examples for improved configurations and methods for imaging the reconstructed image are demonstrated in FIG. 3 and FIG. 4.

According to some embodiments, the gain is positioned at one first focal length (f₁) in front of the first lens.

According to some embodiments, the gain is positioned at length (f₁′) in front of the first lens, where f₁′ compensates for the slower beam velocity within the gain:

f₁′=f₁+L_{gain}(1−n_{gain}⁻¹) Eq. (2)

Where: L_{gain} is the length of the gain medium crystal, and
n_{gain} is the refractive index of the gain medium.

According to some embodiments, the SLM is positioned at one second focal length (f₂) behind the second lens.

According to some embodiments, the mask is positioned at one first focal length (f₁) behind of the first lens, and one second focal length (f2) in front of the second lens;

According to some embodiments, the system further comprising a camera (not shown), configured to photocopy and display an image that appears at the mask's aperture or via the output coupler.

According to some embodiments, the object's SID comprises Furrier magnitudes (absolute value of the object's Fourier transform) of the object's scattered light.

According to some embodiments, the reflective SLM comprises an array of pixels, each pixel's reflectance is controlled independently, optionally via a computer. According to some embodiments the control of the SLM's reflectance is provided offline, before the lasing begins. According to some embodiments, a basic control is used to verify the intensity at each point, as the threshold exact value may be determined by measurement and may not be uniform. According to some embodiments, the non-reflected beam's distribution is scattered.

According to some embodiments, the reflectance of each pixel is determined according to:

$${T}_{S L M} ( \vec{k} ) = exp ( \frac{{g}_{0}}{1 + {\vert {E}_{s o l} ( \vec{k} ) \vert}^{2} / {I}_{sat}} ) = exp ( \frac{{g}_{0}}{1 + {I}_{S I D} ( \vec{k} ) / {I}_{sat}} ) \qquad Eq . ( 3 )$$

where:
T_{SLM}(\vec{k}) is a linear transformation that represents the amplitude transmittances at the SLM;
\vec{k} is the position at the SLM plane;
Iₛₐₜ is the saturation intensity;
g₀ is the linear gain at very low intensities, set by a pumping strength;
E(\vec{k}) is an electric field on the SLM;
I_{SID}(\vec{k})=|Eₛₒₗ(\vec{k})|² is the scattered intensity distribution on the SLM.

According to some embodiments, the object's SID and the object's reconstructed image comprise data from a field selected from: astronomy, X-ray, crystallography, imaging though turbid media, short pulse characterization, speech processing, encryption and decryption, ptychographic imaging, lens-less photography and microscopy, NMR, and synthetic aperture radar. According to some embodiments, further system adjustments may be required for lasing data from a specific field.

According to some embodiments, a method is provided for reconstructing an image of an object from an input comprising: the object's scattered intensity distribution (SID) and the object's compact support, using the laser system 200 as mentioned above; the method comprising:
spontaneously lasing multiple transverse mode beams, via the gain; according to some embodiments, these multiple mode beams are provided as optional projecting origins;
iteratively reflecting the lasing beams between the gain and the SLM via the mask (thereby amplifying the beams via the gain and maintaining the intensity distributions of the object's SID via the SLM), while decaying lasing modes which do not comply with the object's SID and the objects compact support, until only beams with one lasing mode (and optionally its conjugating lasing mode) are left, thereby the one mode (or the two mode) is most probable as an origin mode;
providing the object's reconstructed image at least at the mask's aperture, based on the most probable mode/s.

According to some embodiments, the most probable lasing mode refers to the one/two mode/s, which experiences the least loss during the step of iteratively lasing, thereby selecting the most probable one or two mode/s as the projecting origin mode/s.

According to some embodiments, the method further comprising retrieving phase of the most probable lasing mode. According to some embodiments, the step of retrieving further comprises measuring the most probable lasing mode via an interferometer.

According to some embodiments, the method further comprising monitoring the gain's reflected images via the output coupler.

According to some embodiments, the method further comprising imaging and/or displaying the reconstructed image via the camera.

According to some embodiments, the duration of one iterative reflection depends upon the length of the linear digital degenerate cavity laser (DDCL) system 200. One example is a system with a length of about 1 meter, and accordingly the duration of one iterative reflection is about 6.6 nano-seconds.

Reference is now made to FIGS. 3 and 4, which schematically demonstrate a ring digital degenerate cavity laser (DDCL) systems: system 300 as in FIG. 3 and system 400 as in FIG. 4, having at least some similar features, according to some embodiments of the invention. According to some embodiments, features of some components of systems 300 and 400, and some of their applied methods may be similar to those of system 200 of FIG. 2, as mentioned above.

According to some embodiments, the ring DDCL system 300, 400 as respectively demonstrated in FIGS. 3 and 4 is configured to reconstruct an image of an object 390,490 from an input comprising: the object's scattered intensity distribution (SID) 391,491 and the object's compact support 392,492.

The system 300 as demonstrated in FIG. 3 comprising:
two first lenses 320, one or two second lenses 330, and at least four beam folding elements 312, all arranged in a ring configuration 314 of a first- and a second-four-focal telescopes 310,311 (FIG. 4 demonstrates a ring with one second lens 430, while FIG. 3 demonstrates a ring with two second lens 330);
a gain medium 340, at a first tangent point of the two telescopes, configured to amplify and lase forward beams received from the second telescope 311 towards the first telescope 310;
a transmissive spatial light modulator (SLM) 350, at a second tangent point of the two telescopes, configured to selectively lase forward intensity distribution of beams received from the first telescope towards the second telescope, according to their spatial location, wherein the selective lasing is configured to maintain the intensity distributions of the object's SID;
a spatial intensity binary mask 360, located between the lenses of the second telescope 311, comprising an aperture in the form of the object's compact support 392;

wherein the reconstructed object's image 393 is provided at least at the mask's aperture.

According to some embodiments, the transmissive SLM comprises an array of pixels, each pixel's transmittance is controlled independently, optionally via a computer. According to some embodiments the control of the SLM's distribution transmittance is provided offline, before the lasing begins. According to some embodiments, a basic control is used to verify the intensity at each point, as the threshold exact value may be determined by measurement and may not be uniform. According to some embodiments, the non-transmitted beam's distribution is scattered.

According to some embodiments, each of the beam folding elements is selected from: a mirror, a reflecting surface, a beam splitter, an output coupler, and any combination thereof.

According to some embodiments, one beam folding element, which is located between the second lens of the second telescope and the mask, comprises an output coupler 313 configured to output a small part of its received beam, for monitoring and/or imaging purposes, while the rest and substantial part of the beam continues its (folding) original path. According to some related embodiments, the ring system further comprises a camera 370 and optionally at least one lens (not shown), configured to photocopy and/or display the reconstructed image provided by the output coupler.

According to some embodiments, the ring DDCL system 400, as in FIG. 4, is configured to reconstruct an image of an object 490 from an input comprising: the object's scattered intensity distribution (SID) 491 and the object's compact support 492; the system 400 comprising:
two first lenses 420, a (single) second lens 430, at least six beam folding elements 412, and a first polarization beam splitter (PBS₁) 445; all arranged in a ring configuration of a first- and a second-four-focal telescopes 410,411, where the second lens 430 serves for both telescopes via the first PBS₁ (the path of the first telescope is demonstrated via red arrows 410; the path of the second telescope is demonstrated via blue arrows 411);
a gain medium 440, at a first tangent point of the two telescopes (between the two first lenses 420), configured to amplify and lase forward beams received from the second telescope 411 (blue arrows path) towards the first telescope 410 (red arrows path);
a reflective spatial light modulator (SLM) 450, at a second tangent point of the two telescopes (behind the second lens, when following the first telescope red path 410; and before the second lens, when following the second telescope blue path 411), configured to selectively reflect intensity distribution of beams received from the first telescope towards the second telescope, according to their spatial location, wherein the selective reflecting is configured to maintain the intensity distributions of the object's SID;
a spatial intensity binary mask 460, located between the lenses of the second telescope 411 (blue arrow path), comprising an aperture in the form of the object's compact support 492;

wherein the reconstructed object's image 493 is provided at least at the mask's aperture.

According to some embodiments, the system 400 further comprises at least one of: a Faraday rotator 465 and at least one half wave plate 466,467, configured to rotate their passing through beams, such that they enable the first PBS₁ to pass through beams of the first telescope path (blue arrows) 410 and to reflect and redirect (fold) beams of the second telescope path (blue arrows) 411.

According to some embodiments, the system 400 further comprises a second polarization beam splitter (PBS₂), which is located between the second lens 420 and the SLM 450, configured to redirect a small part of its received beam, for monitoring and/or imaging purposes, while the substantial part of the beam continues its original (blue arrow) path. According to some related embodiments, the system 400 further comprises a camera 470 and optimally at least one lens 471, configured to photocopy and/or display the reconstructed image provided by the second PBS₂.

According to some embodiments, the above mention systems 200,300,400 and their application methods are applicable to any two- or three-dimensional object, with a known compact support constraint, including complex valued objects.

According to some embodiments of the invention, a ring degenerate cavity laser (RDCL) resolves some problems inherent in a linear DCL. The first problem is the overlap between propagating far-field and back propagating inverted far-field intensity distributions, which requires that the far-field aperture masks be centrosymmetric. The second problem is the long gain medium (110 mm) which causes overlap between adjacent lasers intensity distributions inside the gain medium that may lead to intensity instabilities. The RDCL resolved the first problem by separating the two far-fields so they no longer overlap and the third problem by directly imaging the mask to the middle of gain medium. An additional advantage of RDCL is that the direct imaging of the mask to the middle of gain medium need not pass through the far-field aperture that may alter the image fidelity (fidelity is demonstrated in the following).

According to some embodiments, it is recommended to integrate an SLM into the RDCL to form a digital RDCL instead of linear DDCL, mainly because it can operate with non-centrosymmetric aperture in the far-field. This removes a degeneracy in the lasing modes, which cause ambiguity in the measured far-field intensity distributions.

According to some embodiments, the cavity the cavity can be redesigned by adding two delay lines (retroreflectors). One, in the first far-field plane, to compensate for the spherical phase of the SLM and other phase aberrations in the cavity, and the second, in the near-field plane near the gain medium to add Talbot coupling wherever it is needed. The new design combines a twisted-mode laser cavity and 8f ring degenerate cavity laser.

According to some embodiments the advantages of ring degenerate cavity laser systems 300,400 over the linear degenerate cavity laser system 200 are:
an operation with non-centrosymmetric aperture in the far-field;
support of non-centrosymmetric far-field intensity distributions; and
configured to remove a degeneracy in the lasing modes, which cause ambiguity in the measured far-field intensity distributions.
   Further, the ring configuration used Faraday rotator for unidirectional operations of the ring laser to prevent spatial hole burning effect and to reduce the number of longitudinal modes.

According to some embodiments, a method is provided for reconstructing an image of an object from an input comprising: the object's scattered intensity distribution (SID) and the object's compact support, using the laser system 300,400 as mentioned above; the method comprising:
spontaneously lasing multiple transverse mode beams, via the gain;
iteratively reflecting the lasing beams between the gain and the SLM via the mask, while decaying lasing modes which do not comply with the object's SID and the objects compact support, until only beams with one lasing mode and optionally its conjugating lasing mode are left, thereby the one (or two) mode is most probable as an origin mode;
providing the object's reconstructed image at least at the mask's aperture, based on the most probable mode/s.

According to some embodiments, the method further comprising retrieving phase of the most probable lasing mode.

According to some embodiments, method further comprising monitoring the gain's reflected images via an output coupler

According to some embodiments, the method further comprising displaying the reconstructed image via a camera.

According to some embodiments, the duration of one iterative reflection depends upon the length of the ring digital degenerate cavity laser (DDCL) system 300,400. One example is a system with a length of about 5 meters, and accordingly the duration of one iterative reflection is about 16.6 nano-seconds.

### Experimental Arrangement

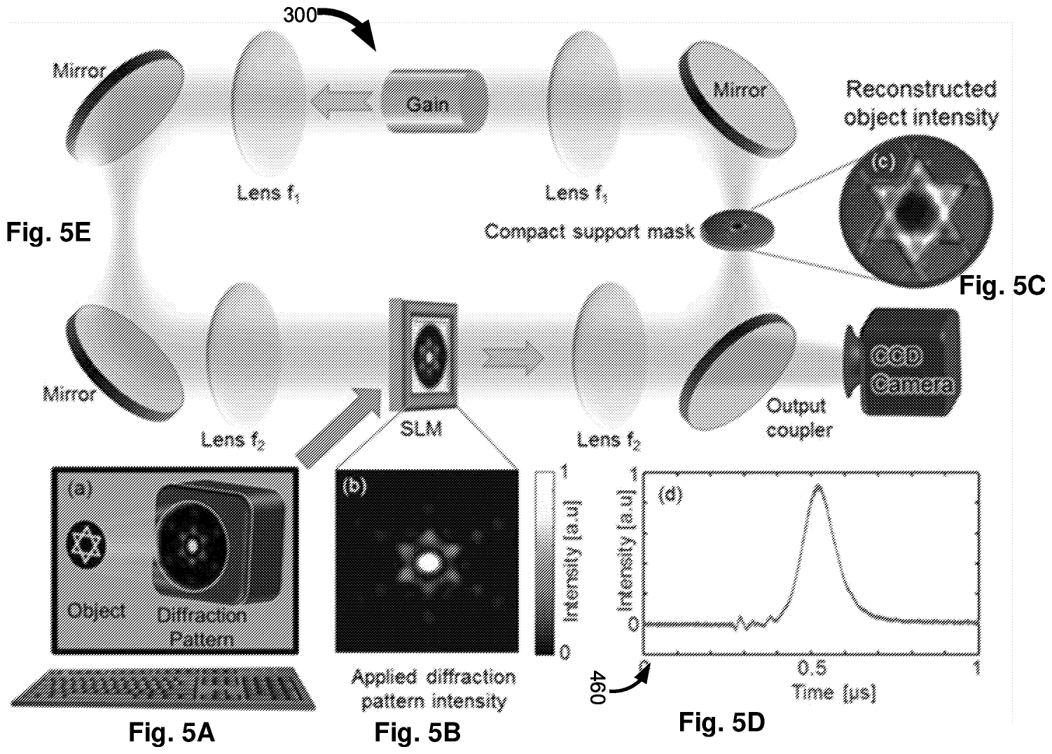

The basic and simplified DDCL ring arrangement for rapidly solving the phase retrieval problem is schematically presented in FIGS. 5A-5E. As shown in FIG. 5E (which is similar to the demonstration of FIG. 3) the system 300 is comprises a ring degenerate cavity laser that includes:
a gain medium,
two four focal telescopes,
an amplitude spatial light modulator (SLM),
an intra-cavity aperture, and
three high reflectivity mirrors and an output coupler; in this example, all at 45°, for a 90° beam folding.

The left side telescope images the center of the gain medium onto the SLM, where the transmittance at each pixel is controlled independently. The intra-cavity aperture, together with the SLM serve to control and form the output lasing intensity distribution.

According to some embodiments, in the absence of the intra-cavity aperture, the right-side telescope simply reimages the SLM back onto the gain medium, so all phase distributions can lase, i.e. the amplification and losses are phase independent.

However, when an intra-cavity aperture (compact support mask) is placed at the Fourier plane between the two lenses, each phase distributions has a different loss. In this case, the phase distribution that experiences the least loss is the most probable original lasing mode, due to mode competition.

According to some embodiments, with a specific scattered intensity distribution applied onto the SLM and a specific size and shape of the intra-cavity aperture (compact support), which determine the two constraints of the phase retrieval problem, the most probable lasing mode corresponds to the solution. The image of the reconstructed object appears within the intra-cavity aperture and can be imaged through the output coupler onto the camera.

FIG. 5A demonstrates a scattered intensity distribution from the object, which is applied onto a spatial light modulator (SLM), which is incorporated into a ring degenerate cavity laser that can support up to 100,000 degenerate transverse modes, according to some embodiments of the invention.

FIG. 5B demonstrates a mask, shaped as the object boundaries (compact support), located at the Fourier plane; the mask filters out extraneous modes that do not match the compact support. According to some embodiments of the invention, with this laser arrangement, the lasing process yields a self-consistent solution that satisfies both the scattered intensity distribution and the compact support constraint.

FIG. 5C demonstrates the reconstructed object intensity, as it appears at the compact support mask and imaged onto the camera.

FIG. 5D demonstrates laser intensity as a function of time. According to some embodiments, the duration of the lasing process (convergence to a solution) is set at about 100 nano-seconds by incorporating a Pockels cell (not shown) into the laser cavity.

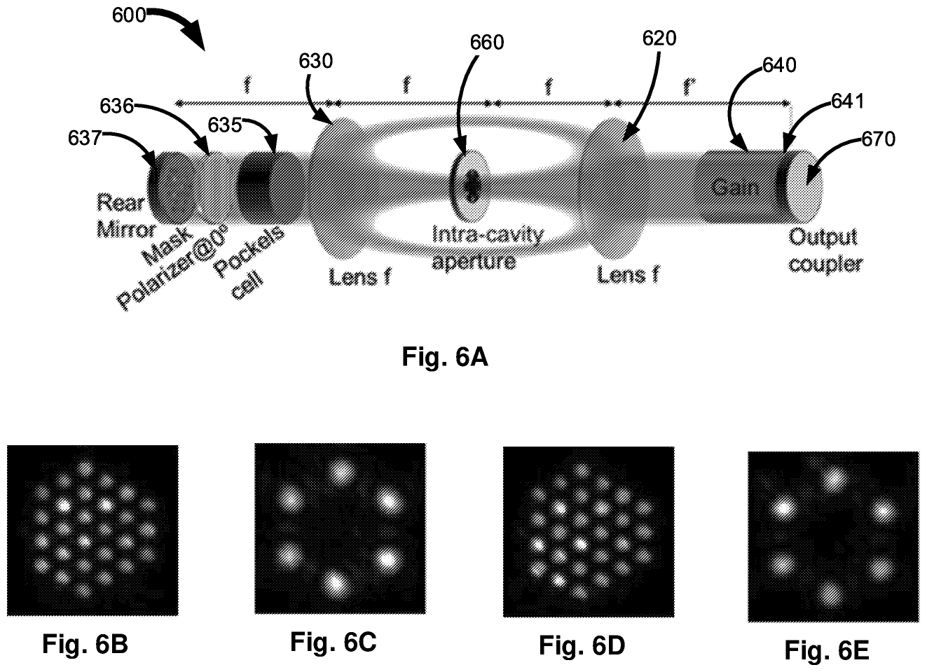

According to some embodiments, in order to determine the upper bound for the minimum duration needed for the object reconstruction, the experimental arrangement can be modified to a Q-switched linear degenerate cavity laser, by using a Pockels cell, as demonstrated in FIG. 6A, to measure the duration of the shortest lasing pulse and its effect on the reconstructed object.

It is noted that the results for the 100 nano-second Q-switched lasing operation, with the pulse profile as shown in FIG. 5D, were essentially the same as those for quasi continues wave-(QCW) lasing operation. Additional details are presented in the following for FIGS. 6A-6E.

### Experimental Results

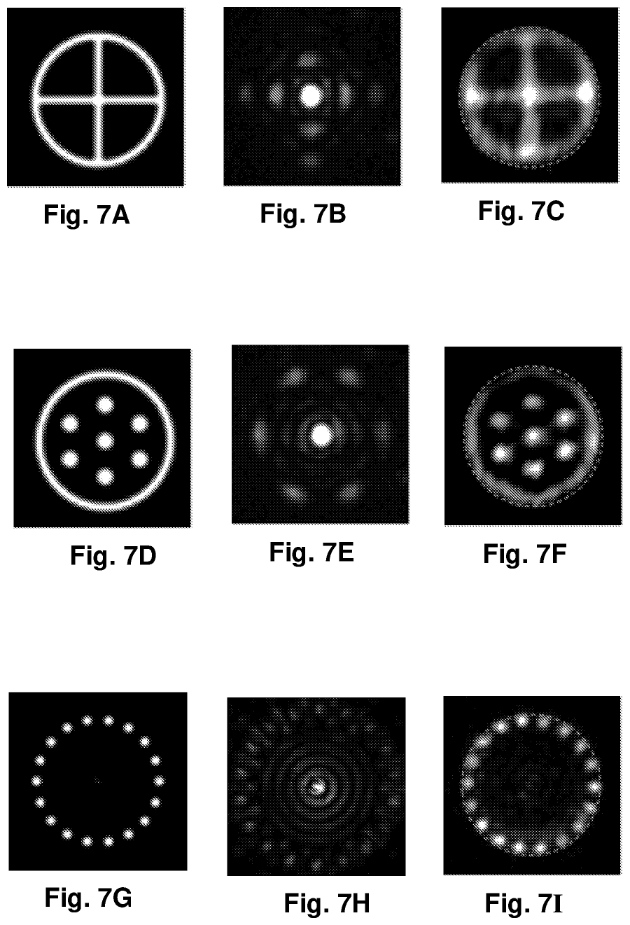

The ring DDCL system 400 of FIG. 4 was used to reconstruct several different objects; the system's simplified model/design is demonstrated in FIGS. 3 and 5A-5D. In the following, representative experimental results for the different objects are presented in FIGS. 7A-7I, FIGS. 8A-8L and FIGS. 9A-9H.

In the experiments, two features of merit are considered to quantify the quality of the solver: the computation time and the reconstruction fidelity. Two different processes set the overall computation time. The first process includes the overhead durations for forming the specific intensity pattern on the SLM and for detecting the solution with a camera. These durations are dictated by the SLM response time and the CMOS camera readout time, and together are about 20 milli-seconds (ms). The second important process is the actual computation time of lasing, which is less than 100 nano-seconds ns. Unlike most other computational devices, where the input/output overhead duration is negligible compared to the computation time, in the current system it is the bottleneck in the total computation time. Fortunately, this bottleneck can be alleviated (reducing overhead durations to sub-milliseconds) by resorting to improved input/output devices, which are continuously becoming available.

The other feature of merit is the reconstruction fidelity, defined as:

Fidelity=1−½∥I_{det}(x)−I_{orig}(x)∥_{2′} Eq. (4)

### Where:

I_{det} is the aligned normalized intensity of the detected reconstructed object [or Fourier distribution],
I_{orig} is the normalized intensity of the original object (or calculated Fourier distribution), and
∥I(x)∥₂ is the L₂ norm of an intensity pattern I(x)
L₂ of x is the distance from zero and defined as ∥x∥₂=\sqrt{Σx²}

Reference is now made to Error! Reference source not found. FIG. 7A-7I, which demonstrate the results for the reconstruction of three different centrosymmetric objects, with uniform phase distribution and compact support as circular aperture, according to some embodiments of the invention. FIGS. 7A, 7D and 7G (left column): demonstrate the intensity distributions of the actual objects. FIGS. 7B, 7E and 7H (middle column): respectively demonstrate their corresponding Fourier intensity distributions, applied to control the SLM. FIGS. 7C, 7F and 7I (right column): respectively demonstrate their detected reconstructed objects, using a circular aperture as compact support. As evident, there is good agreement between the original object and the reconstructed object. Image blurring is attributed to ambiguities, low dynamic range, inaccurate compact support, and inaccurate intensity distribution on the SLM (digitization effect) because of limited resolution and laser intensity fluctuations.

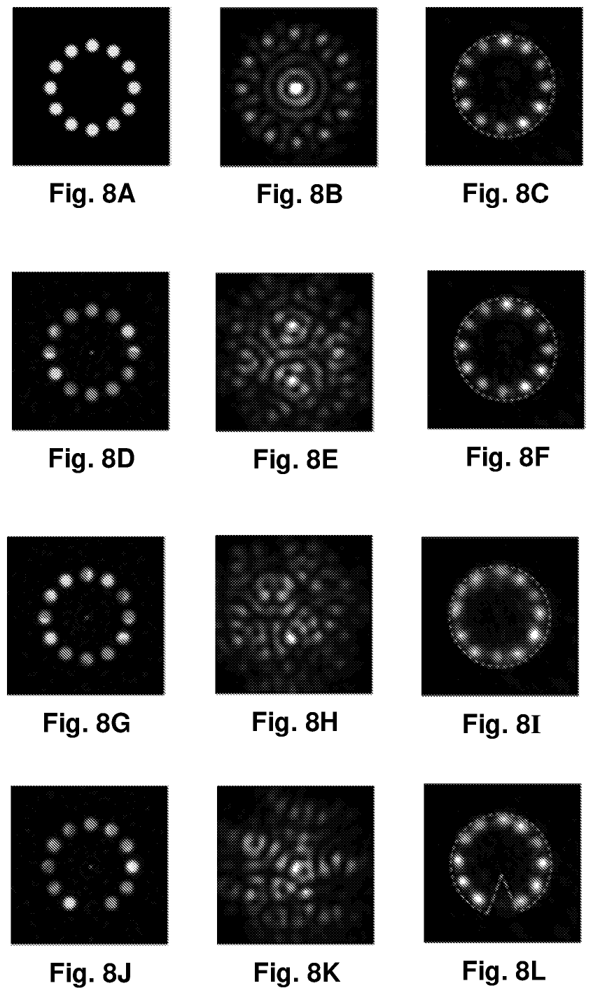

Reference is now made to FIG. 8A-8L, which demonstrate the reconstruction of four similar objects, each with a different phase distribution and therefore different scattered intensity distribution, using their various complex phase distributions and compact support with a circular aperture, according to some embodiments of the invention. FIGS. 8A, 8D, 8G and 8J (left column): demonstrate intensity (brightness) and phase (hue) distributions of four actual objects. FIGS. 8B, 8E, 8H and 8K (middle column): respectively demonstrate their corresponding Fourier intensity distributions, applied to control the SLM. FIGS. 8C, 8F, 8I and 8L (right column): respectively demonstrate their detected reconstructed objects, using mainly a circular aperture as compact support (excluding FIG. 8L). The first row (FIGS. 8A-8C) demonstrates an object with uniform phase distribution; the second row (FIGS. 8D-8F) demonstrates the same object with arbitrary centrosymmetric phase distribution; the third row (FIGS. 8G-8I) demonstrates the same object with random, asymmetric phase distribution; and the fourth row (FIGS. 8J-8L) demonstrates a non-centrosymmetric object with random asymmetric phase distribution. The first row shows the results for an object with uniform phase distribution (i.e. a real valued object), where the corresponding scattered intensity distribution has a 12-fold symmetry. As evident, the reconstructed object is very similar to the actual object. The second row shows an object with centrosymmetric phase distribution, so both the object and the corresponding Fourier intensity distribution are centrosymmetric. Here again, the reconstructed object is quite similar to the actual object. The third row shows an object with random, asymmetric phase distribution, so the corresponding Fourier intensity distribution is also asymmetric. As evident, the reconstructed object is blurred and differs from the actual object; this blurring is attributed to interferences between two degenerate solutions (the image of the object and that of the inverted phase conjugate). The fourth row shows a similar non-centrosymmetric object with random phase distribution, so the corresponding Fourier intensity distribution is also asymmetric. Here, the reconstructed object is quite similar to the actual object despite the random phase distribution because of the non-centrosymmetric compact support, which removes the degeneracy between the two trivial solutions.

It is note that the current system correctly reconstructs the actual objects even though the Fourier intensity distributions for rows one and two are strikingly different. The high quality reconstructions (reconstruction fidelities of 0.81-0.91) indicate that the current approach is also valid for complex-valued objects, which are generally harder to solve computationally.

According to the Wiener-Khinchin theorem [Norbert Wiener (1964). Time Series. M.I.T. Press, Cambridge, Mass. p. 42], the L₂ norm of the difference between the reconstructed object and the original object is identical in the Fourier and real spaces. In the current DDCL phase retrieval solver, the difference in Fourier intensity distributions is attributed mainly to the phases, since the intensities are almost identical. Therefore, measuring the distance in real space gives a good estimation for the error in the reconstructed phase. The high fidelity of the objects reconstructions indicates that the phases reconstructed as well even though they were not directly measured.

A known ambiguity in phase retrieval emerges when the object is non-centrosymmetric, but the assumed compact support is centrosymmetric. An example for such a case is shown in FIGS. 8G-8I, where the object has a random, asymmetric phase distribution, so the corresponding Fourier intensity distribution is also asymmetric. Here, the reconstruction fidelity is only 0.81 and the blurred reconstructed object differs from the actual object due to interferences between two degenerate solutions (one is the image of the object and the other the inverted phase conjugated image). Applying non-centrosymmetric compact support (for a non-centrosymmetric object), removes this degeneracy, and ensures high quality reconstruction with fidelity of 0.91, as seen in the FIGS. 8J-8L.

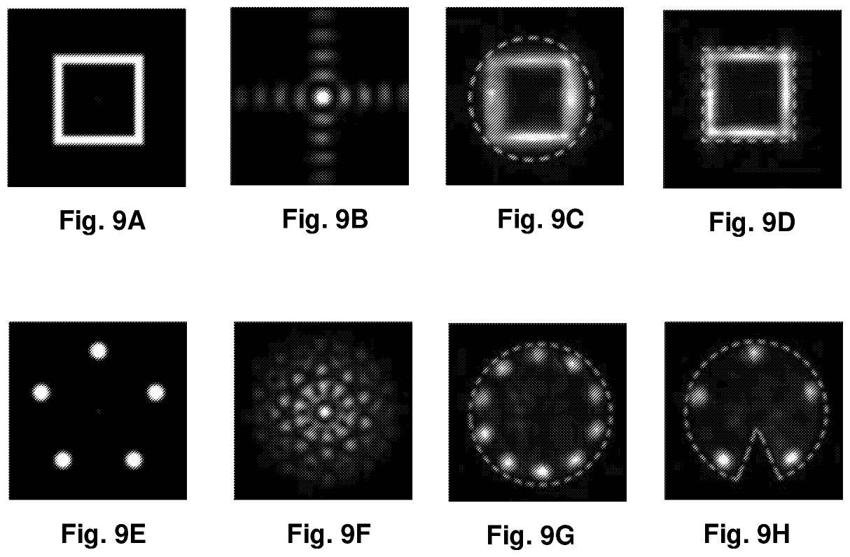

Reference is now made to FIG. 9A-9H, which demonstrate representative experimental results for an investigation of the effect of tightness and symmetry of the compact support on the reconstruction quality, according to some embodiments of the invention. FIGS. 9A and 9E: demonstrate intensity distribution of two different actual objects. FIGS. 8B and 9F: respectively demonstrate their detected corresponding Fourier intensity distributions, applied to control the SLM. FIGS. 9C and 9G: respectively demonstrate their detected reconstructed objects, using a circular aperture as compact support. FIGS. 9D and 9H: respectively demonstrate their detected reconstructed objects, using a tight compact support: a square was used at FIG. 9D and a circular aperture with a wedge as asymmetric compact support was used at FIG. 9H. The results in the first row (FIGS. 9A-9D) demonstrate that a tight compact support (square rather than a circular aperture) significantly improves the quality of reconstructed square object. Yet, since both the object and the support are centrosymmetric, even the non-tight circular aperture leads to a reasonable reconstruction. The results in the second row (FIGS. 9E-9H) demonstrate the importance of centrosymmetry. The object in this case is non-centrosymmetric, so when the compact support is centrosymmetric (circular aperture in column c), two different solutions—the reconstructed object and its centro-inverted version—are compatible with the constraints [Bruck el al.], and as evident both are obtained. However, by adding a wedge to the compact support, the centrosymmetry of the compact support is broken, and only the actual object distribution is compatible with the constraints. Note that a similar approach is commonly used in several phase retrieval algorithms in order to resolve ambiguities and improve the reconstructed object [Siegman, A. Lasers. (University Science Books, Mill Valley, Calif., 1986)].

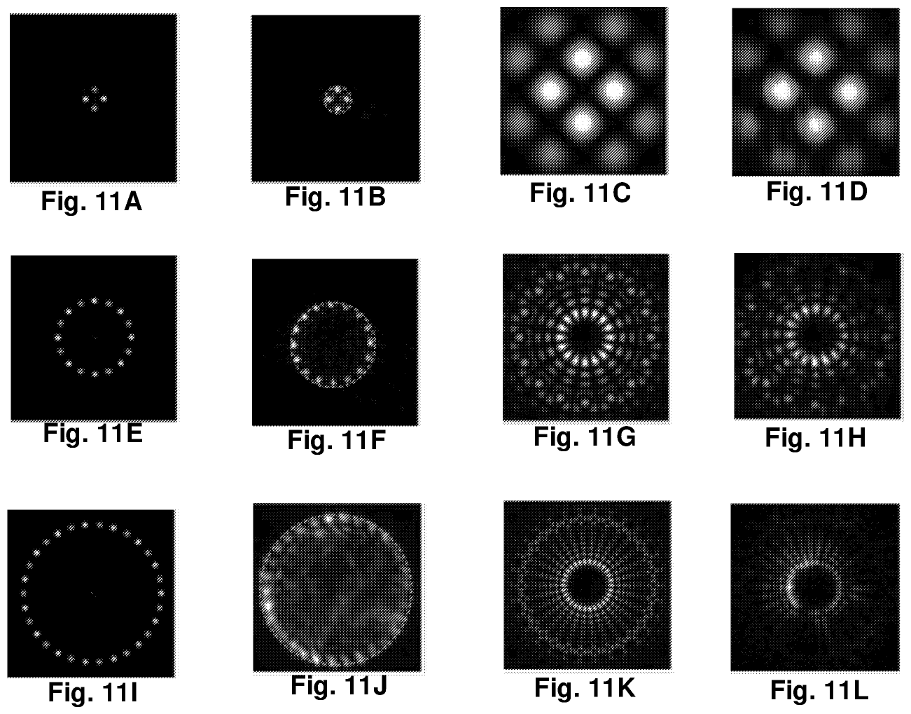

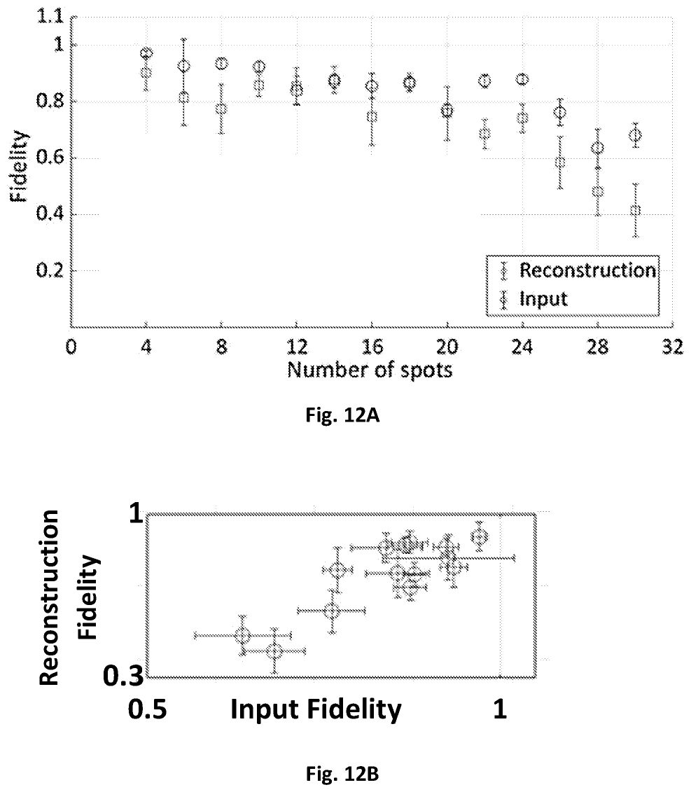

Quantitative results about the effect of object complexity on the reconstruction fidelity are presented in FIGS. 11A-11L and in FIGS. 12A-12B. FIGS. 11-A-11L demonstrate representative intensity distributions of objects with 4, 16 and 30 spots. FIGS. 11A, 11E and 11I respectively demonstrate intensity (brightness) and phase (hue) distributions of the actual objects. FIGS. 11B, 11F and 11J respectively demonstrate detected intensity distribution of the reconstructed objects using a circular aperture as compact support. FIGS. 11C, 11G and 11K respectively demonstrate calculated Fourier intensity distributions applied to control the SLM. FIGS. 11D, 11H and 11L respectively demonstrate detected corresponding Fourier intensity distributions after modifications by SLM properties. FIG. 12A demonstrates their (FIGS. 11A-11L) quantitative fidelity values of the Fourier intensity distributions (blue) and the reconstructed object intensity distributions (red) as function of the number of spots in the object (4 to 30). FIG. 12B demonstrates fidelity values of the reconstructed object intensity distributions as function of the fidelity values of the Fourier intensity distributions for all the measurements

The intensity distributions of the original objects consisted of an array with an even number of spots, having alternating phases of 0 and π (to prevent strong intensity peak at the Fourier center), arranged in a ring geometry. The number of spots ranged from 4 to 30 and the sizes of all spots were the same. The corresponding Fourier intensity distributions were determined at the SLM before and after modifications by the SLM properties. Then, 48 realizations of the Fourier intensity distributions were measured and the reconstructed object intensity distributions, for each number of spots. Finally, the fidelity of the input Fourier intensity distributions was calculated, and the reconstructed object intensity distributions were calculated as a function of the number of spots in the object.

These indicate that more complex objects (with more spots) have a more complicated Fourier intensity distributions with smaller details that cannot be properly resolved by our SLM. The quantitative experimental results for the fidelity as a function of object complexity (number of spots) are shown in FIGS. 12A and 12B, where the average correlation between the input and reconstructed fidelities in the inset is 0.76. The fluctuations in the fidelity of the input Fourier intensity distributions derives from instabilities in the pumping method (flash lamp in our arrangement), which could be improved by diode pumping. The fidelity correlation results demonstrate that improving the fidelity of the calculated and measured input Fourier intensity distributions improves the fidelity of the reconstructed object.

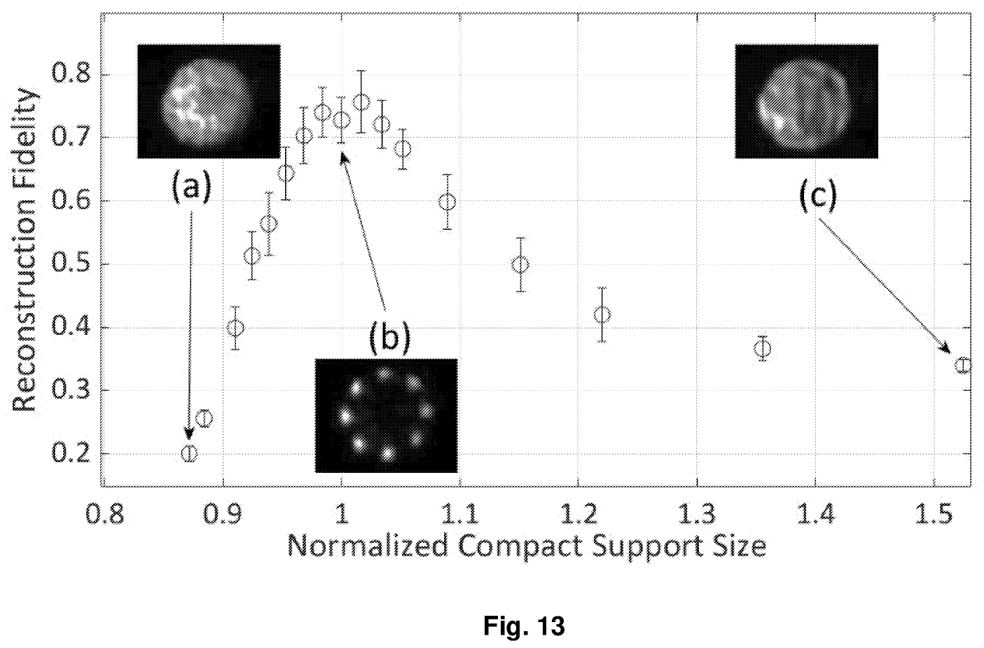

The quantitative effect of tightness of the size of the compact support on the reconstruction quality and fidelity is presented in FIG. 13, which demonstrates experimental quantitative results for reconstruction fidelity as function of the compact support radius of the aperture normalized by the object size. The insets are typical reconstructed object intensity distributions for: (a)—compact support radius is 152% of the object radius, (b)—object radius is equal to compact support radius, (c)—compact support radius is 87% of the object radius.

It shows the reconstruction fidelity as function of the radius of the compact support aperture normalized by the object size and representative intensity distributions in insets (a-c). As expected, when the object size is bigger than the compact support, there is a rapid decay in the reconstruction fidelity, since the laser cannot support the correct object shape, and when the object size is smaller than the compact support there is slower decay in the fidelity due to overlap of multiple solutions supported by the aperture.

### Discussion

The lasing mode in the ring DDCL system 400, as in FIG. 4, is a complex field at the SLM, E(\vec{k}, t) where \vec{k} is the position at the SLM plane, mapped onto itself after propagating through the cavity. In other words, it is a stationary solution of the field propagation equation, which for a cavity round-trip of duration τ can be written as:

E(\vec{k},t+τ)=T_{SLM}(\vec{k})G(\vec{k},t) [symbol] ⁻¹[M(\vec{x}) [symbol] [E(\vec{k},t)]], Eq. (5)

where T_{SLM}(\vec{k}) is the amplitude transmittances at the SLM, G(\vec{k},t) is the (nonlinear) gain of the system, [symbol] is a 2D Fourier transform (performed by the lenses), and M(\vec{x}) represents the spatial compact support imposed by the intra-cavity mask, where \vec{x} is the position at the mask plane. Note, that the mapping of E(\vec{k},t) is nonlinear, due to the non-linear gain with saturation G(\vec{k},t)=exp(g₀(1+|E(\vec{k},t)|²/Iₛₐₜ)⁻¹), where g₀ is the linear gain at very low intensities set by the pumping strength, and Iₛₐₜ is the saturation intensity.

Now consider the electric field Eₛₒₗ(\vec{k}), which corresponds to the solution for the phase retrieval problem. This field passes through the compact support without any changes, [symbol] ⁻¹[M(\vec{x}) [symbol] [Eₛₒₗ(\vec{k})]]=Eₛₒₗ (\vec{k}). Assuming that Eₛₒₗ(\vec{k}) is a stable, time independent solution of Eq. (5), so T_{SLM}(\vec{k})Gₛₒₗ(\vec{k})=1. With this T_{SLM}(\vec{k})=exp(−g₀(1+|Eₛₒₗ(\vec{k})|²/Iₛₐₜ)⁻¹), the solution of the phase retrieval is a possible lasing mode in the system. Substituting the expressions for T_{sLM}(\vec{k}) and G(\vec{k},t) into Eq. (5), yields:

$$E ( \vec{k} , t + τ ) = exp ( {g}_{0} ( \frac{1}{1 + {\vert E ( \vec{k} , t ) \vert}^{2} / {I}_{s a t}} - \frac{1}{1 + {\vert {E}_{s o l} ( \vec{k} ) \vert}^{2} / {I}_{s a t}} ) ) {ℱ}^{- 1} [ M ( \vec{x} ) ℱ [ E ( \vec{k} , t ) ] ] \qquad Eq . ( 6 )$$

According to some embodiments, Eq. (6) can be considered as a modified GS iterative projection process, in which the fastest growing mode corresponds to the solution.

According to some embodiments, at the transition to lasing, the amplified spontaneous emission (ASE) modes with the highest energy wins the mode competition over the limited gain. In the initial growth stage of the electric field inside the cavity, |E(\vec{k},t)|² of each ASE mode is extremely small. Therefore, Eq. (6) can be approximated as:

$$E ( \vec{k} , t + τ ) \text{∼} exp ( {g}_{0} ( \frac{{\vert {E}_{s o l} ( \vec{k} ) \vert}^{2} / {I}_{s a t}}{1 + {\vert {E}_{s o l} ( \vec{k} ) \vert}^{2} / {I}_{s a t}} ) ) {ℱ}^{- 1} [ M ( \vec{x} ) ℱ [ E ( \vec{k} , t ) ] ] . \qquad Eq . ( 7 )$$

Under this approximation, the round-trip mapping is linear. The fastest growing mode in this stage is hence the eigenmode of the linear mapping with the highest eigenvalue. When Iₛₐₜ>>|Eₛₒₗ(\vec{k})|², Eq. (7) is to a good approximation a projection on the compact support. Hence, all modes within the support grow exponentially faster than other modes. Thus, the solutions of the phase retrieval problem are both the fastest growing modes in the initial stage and the stable lasing modes. Moreover, since the phase retrieval problem has a unique solution, it assures that Eₛₒₗ(\vec{k}) would be the only stable lasing mode from all the modes with a certain compact support. Thus, if the solution is present in the ASE, it is expected to be the lasing configuration of the system.

According to some embodiments, there may be additional stable lasing modes in the nonlinear cavity that can lead to a wrong solution. Out of the possible stable lasing modes, which one is chosen by the system as the actual lasing mode. Before the lasing transition, the gain operates in the incoherent ASE regime, where the number of different phase configurations is very large, as quantified below. Each of these configurations evolves according to Eq. (6). Out of all these time evolving phase configurations, the one with the highest energy (smallest loss) wins the mode competition over the limited gain. Therefore, the larger the number of initial independent configurations, the higher the probability of the system to find the correct solution, which is the unique stable configuration with no losses on the compact support mask.

Therefore, the number of different ASE phase realizations inside the cavity are evaluated. This number quantifies the independent parallel “computations” running simultaneously inside the cavity, out of which the optimal configuration wins the mode competition. A phase configuration is defined by a set of N phases, one for each of the N spatial modes in the cavity (i.e. the phase at each pixel on the SLM). For ASE, each spatial mode has a coherence length dictated by the bandwidth. The length of the cavity divided by this coherence length therefore dictates the number of different phases in each spatial mode in the cavity, denoted by K—the number of longitudinal modes. Importantly however, in ASE the different spatial modes are independent. For simplicity, a model of the phase of each spatial mode is evaluated to evolve as a Poisson process with an average time between phase changes corresponding to the coherence length. Under this assumption, for N independent spatial modes the rate at which the phase configuration changes is N times larger than that of a single mode. Therefore, the overall number of different phase realizations in the cavity is the number of longitudinal modes K times the number of spatial modes N, namely KN.

In practice, the current laser does not lase in a single longitudinal mode, although the number of modes decreases by a factor of 10. For Nd-YAG around 1064 nm, the ASE coherence length is about 2 mm, hence in our 5 m cavity there are about 2500 independent longitudinal modes. The number of spatial modes was estimated by the number of pixels in the SLM, to be about 10⁶, where the accurate number depends of the model of SLM (like screens resolutions). Therefore, overall the number of different initial conditions is about 10⁹, and the number of final realizations in the cavity is about 10², hence the current system can be viewed as about 10⁷ independent parallel realizations.

For non-centrosymmetric objects but centrosymmetric support, there are always at least two stable solutions for the lasing mode. One representing an image of the object and the other its inverted complex conjugated image, both with the same compact support and the same spectral intensity [Fienup et al. 1987]. Thus, for such objects, the lasing solution might alternate between the two at any realization, and a mixture of them is expected to be observed in practice.

### Remarks

An all-optical system is presented for rapid phase retrieval, using a novel digitally controlled degenerate cavity laser system. An upper bound on the time needed to reach a solution was set at 100 nano-seconds, orders of magnitude faster than needed for phase retrieval algorithms with conventional computer systems. Although the resolution of the reconstructed objects was relatively low, the ultra-fast convergence to a phase retrieval solution was clearly demonstrated.

Several modifications to the system can potentially improve the quality of the reconstructed objects. For example, resort to other numerical algorithms, such as hybrid input-output (HIO) algorithm [Fienup et al. 1978] where a small feedback can dramatically improve the rate of convergence of the system; such a feedback can be implemented in our system with a delay line. Another example is to resort to a sparsity constraint, by means of a saturable absorber inside the cavity.

Although the DDCL can solve phase retrieval problems in less than 100 ns, setting the scattered intensity distribution as the input on the SLM could take at least a few milliseconds. A direct approach, which uses the scattered light from the unknown object as on-axis structured pump could significantly speed up the process.

### Experimental Methods

In the experiments a reflective phase only SLM was used (as in FIG. 4), instead of the transmissive amplitude SLM in the laser arrangement as shown in FIGS. 3 and 5E. The reflective SLM has a relatively high light efficiency and high damage threshold.

Accordingly, the laser arrangement was modified to retain the same operation functionality. The detailed experimental arrangement that includes the reflective SLM is presented in FIG. 4 in the ring DDCL system 400, along with an explanation on how a phase-only SLM together with the intra-cavity aperture can control the amplitude transmittance of each effective pixel in the SLM [Fienup, J. R. Phase retrieval algorithms: a comparison. Appl. Opt. 21, 2758 (1982)].

In the experimental arrangement as in FIG. 4, the laser gain medium was a 1.1% doped Nd-YAG rod of 10 milli-meter (mm) diameter and 11 cm long. For quasi-CW operation, the gain medium was pumped by a 100 μsec pulsed Xenon flash lamp operating at a repetition rate of 1 Hz to avoid thermal lensing. Each 4f telescope was comprised of two plano-convex lenses, with diameters of 50.8 mm and focal lengths of f₁=750 mm and f₂=500 mm at the lasing wavelength of 1064 nm. The SLM was Hamamatsu (LCOS-SLM X13138-03) with high reflectivity of about 98% at the wavelength of 1064 nm, high resolution and high damage threshold. For Q-switch operation, a Pockels cell was incorporated into a linear DCL of the same gain and pump as for the quasi-CW operation, and the focal lengths of two lenses in the telescope were 250 mm. Additional details are presented in the supplementary.

The detailed experimental arrangement of the digital degenerate cavity laser (DDCL) is schematically presented in FIG. 4. It is comprised of a ring degenerate cavity laser that includes a gain medium, two 4f telescopes with one common lens, a phase only spatial light modulator (SLM), an intra-cavity aperture, two retroreflectors and pentaprism-like 90° reflector (all from high reflectivity mirrors), two polarizing beam splitters (PBS), two half wave plates (λ/2) and a Faraday rotator.

The operation of the detailed arrangement is essentially the same as that of the basic arrangement presented in FIG. 5E (also FIG. 3). Each of the two 4f telescopes has one lens f₁ and a common lens f₂. The first telescope images the field distribution at the center of the gain medium onto the SLM where the reflectivity of each effective pixel is controlled [Ngcobo, S., Litvin, I., Burger, L. & Forbes, A. A digital laser for on-demand laser modes. Nat. Commun. 4, 2289 (2013)].

The second telescope, which contains an intra-cavity aperture, images the field distribution at the SLM that will result in lowest losses back onto the gain medium. Such a distribution is determined by the size and shape of intra-cavity aperture (compact support).

Since the SLM operates on axis and by reflection on horizontal polarized light, half of the ring degenerate cavity was designed as a twisted-mode [Evtuhov, V. & Siegman, A. E. A ‘Twisted-Mode’ Technique for Obtaining Axially Uniform Energy Density in a Laser Cavity. Appl. Opt. 4, 142-143 (1965)] linear degenerate cavity [Arnaud, J. A. Degenerate optical cavities. Appl. Opt. 8, 189-195 (1969)] and the other half as regular ring cavity laser [Arnaud]. The two halves are connected by a first PBS₁, which separates the two counter propagating beams to two different cross-polarized paths. A large aperture Faraday rotator together with a half wave plate (HWP) at 22.5° and another (second) PBS₂ (which also serves as ˜5% output coupler) enforce unidirectional operation of the ring cavity. A 90° reflector flips left and right areas of the beam. The left retroreflector can compensate for free propagation diffraction in the cavity. The right retroreflector can compensate for phase spherical aberrations in the cavity. A second HWP at 45° rotates the polarization from vertical to horizontal to pass through the first PBS₁.

The detection arrangement includes a CMOS camera and lenses so both the near-field and the far-field intensity distributions can be detected.

The local reflectivities of the SLM are determined by the local phase difference of adjacent pixels that affects the amount of light diffracted outside the cavity, and the phases are determined by the local phase average of the adjacent pixels. For example, adjacent pixels with phases of [0, 0] will result in high reflectivity and 0 phase, whereas adjacent pixels with phases of [0,π] will result in no reflectivity and π/2 phase. The overall reflectivity pattern can be used to form any desired intensity distribution and the phase distribution can be used to overcome aberrations in the cavity in order to increase the laser degeneracy. For the phase retrieval problem, the SLM is controlled such that its overall reflectivity pattern matches the intensity distribution but does not add any relative phases between the pixels. Therefore, the lasing frequencies of all the pixels are identical, leading to an interference pattern in the Fourier plane (i.e. in the compact support mask location), which is the solution to the phase retrieval problem (reconstructed object).

### Convergence Time to Reach a Solution

In order to determine the time, it takes the laser to solve the phase retrieval problem, the duration of the lasing was limited to a very narrow pulse. For this purpose, a Q-switched linear degenerate cavity laser (DCL) system was restored, schematically presented in FIG. 6A. The Q-switched linear DCL system 600 comprises: a gain 640 with a partial mirror 641 and an output coupler 670, two lenses 620,630 in a 4f telescope with a Pockels cell 635 and two intra-cavity amplitude masks. The first mask 636 was placed near the rear mirror 367 and enforced a specific scattered intensity distribution of the phase retrieval problem. Here a metallic binary amplitude mask was used, instead of SLM, due to high peak power of Q-switched operation of the laser and the limited damage threshold of the SLM. The second mask 660 was placed between the two lenses and served as the compact support of the reconstructed object.

The results are presented in FIGS. 6B-6D. These show the intensity distribution at the mask (representing the scattered intensity distribution from the unknown object) and the intensity distribution of the reconstructed object at the compact support plane. FIGS. 6B and 6C show the results at quasi-CW lasing (no Q switch), and FIGS. 6D and 6E show the results at Q-switched lasing operation with pulse duration of 100 ns (shown in FIG. 5D). As evident, the short duration of the pulse does not affect the quality of the reconstructed object. Although it is estimated that the convergence time to reach a solution would be significantly shorter than 100 ns, this value is set as the upper bound.

### More Simulation Results

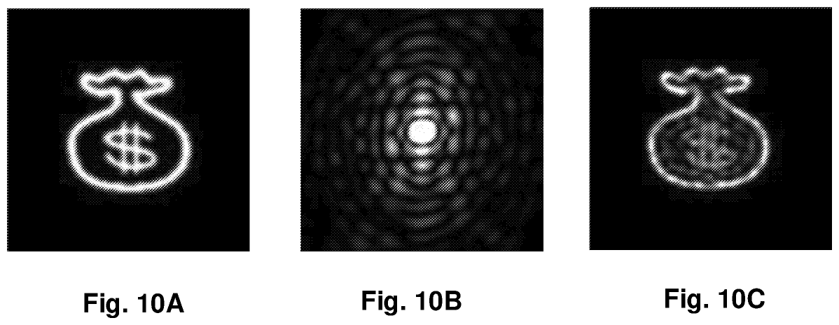

The field distribution of the transverse mode was simulated inside the laser cavity in the arrangement shown in FIG. 4, by resorting to a modified Gerchberg-Saxton (GS) iterative algorithm. In the simulation, the system included the phase only SLM, laser gain medium and the aperture shaped as compact support of the object. The simulation started with an initial guess of a random field distribution at the SLM plane, and then resorted to the iterative algorithm according to Eq. (7). In each iteration, the field of the next round trip was calculated from the current one. Representative simulation results are presented in FIGS. 10A-10C.

FIG. 10A shows an image of the actual scattering object. FIG. 10B shows the simulated intensity distribution of the diffraction pattern inside the cavity. FIG. 10C shows the reconstructed intensity distribution of the object after 100 iterations inside the laser cavity. The compact support shape in this example was the outer boundary, while the details inside were reconstructed by the algorithm.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A laser system configured to reconstruct an image of an object from an input comprising: the object's scattered intensity distribution (SID) and the object's compact support; the system comprising:
a first lens and a second lens, in a four-focal telescope configuration;
a gain with a mirror at one end, at first end of the telescope, configured to amplify and reflect a received beam;
a reflective spatial light modulator (SLM), at second end of the telescope, configured to selectively reflect intensity distributions of a received beam, according to their spatial location, wherein the selective reflection is configured to maintain the intensity distributions of the object's SID;
a spatial intensity binary mask, located between the telescope's lenses, comprising an aperture in the form of the object's compact support; the mask is configured to transfer only beams passing through the aperture;
wherein the reconstructed object's image is provided at least at the mask's aperture.

2. The system according to claim 1, wherein at least one of the following holds true:
the gain is positioned at one first focal length (f1) in front of the first lens;
the SLM is positioned at one second focal length (f2) behind the second lens;
the mask is positioned at one first focal length (f1) behind of the first lens, and one second focal length (f2) in front of the second lens;
the gain's mirror is a partial mirror, configured to output a fraction of the gain's reflected image;
further comprising a camera, configured to photocopy and display the reconstructed image.

3. The system according to claim 1, wherein the object's SID comprises Furrier magnitudes of the object's scattered light.

4. The system according to claim 1, wherein the SLM comprises an array of pixels, each pixel's reflectance is controlled independently, optionally via a computer.

5. The system according to claim 4, wherein reflectance of each pixel is according to:
$${T}_{S L M} ( \vec{k} ) = exp ( \frac{{g}_{0}}{1 + {\vert {E}_{s o l} ( \vec{k} ) \vert}^{2} / {I}_{sat}} ) = exp ( \frac{{g}_{0}}{1 + {I}_{S I D} ( \vec{k} ) / {I}_{sat}} )$$
where:
T_{SLM}(\vec{k}) is a linear transformation that represents the amplitude transmittances at the SLM;
\vec{k} is the position at the SLM plane;
Iₛₐₜ is the saturation intensity;
g₀ is the linear gain at very low intensities, set by a pumping strength;
E(\vec{k}) is an electric field on the SLM;
I_{SID}(\vec{k})=|Eₛₒₗ(\vec{k})|² is the scattered intensity distribution on the SLM.

6. The system according to claim 1, wherein the object's SID and the object's reconstructed image comprise data from a field selected from: astronomy, X-ray, crystallography, imaging though turbid media, short pulse characterization, speech processing, encryption and decryption, ptychographic imaging, lens-less photography and microscopy, NMR, and synthetic aperture radar.

7. (canceled)

8. (canceled)

9. A laser ring system configured to reconstruct an image of an object from an input comprising: the object's scattered intensity distribution (SID) and the object's compact support; the system comprising:
two first lenses, one or two second lenses, and at least four beam folding elements, all arranged in a ring configuration of a first- and a second-four-focal telescopes;
a gain medium, at a first tangent point of the two telescopes, configured to amplify and lase forward beams received from the second telescope towards the first telescope;
a transmissive spatial light modulator (SLM), at a second tangent point of the two telescopes, configured to selectively lase forward intensity distribution of beams received from the first telescope towards the second telescope, according to their spatial location, wherein the selective lasing is configured to maintain the intensity distributions of the object's SID; or
a reflective spatial light modulator (SLM), at a second tangent point of the two telescopes, configured to selectively reflect intensity distribution of beams received from the first telescope towards the second telescope, according to their spatial location, wherein the selective reflecting is configured to maintain the intensity distributions of the object's SID;
a spatial intensity binary mask, located between the lenses of the second telescope comprising an aperture in the form of the object's compact support;
wherein the reconstructed object's image is provided at least at the mask's aperture.

10. The system according to claim 9, wherein the object's SID comprises Furrier magnitudes of the object's scattered light.

11. The system according to claim 9, wherein the transmissive or reflective SLM comprises an array of pixels, each pixel's transmittance or reflectance is controlled independently, optionally via a computer.

12. The system according to claim 11, wherein transmittance or reflectance of each pixel is according to:
$${T}_{S L M} ( \vec{k} ) = exp ( \frac{{g}_{0}}{1 + {\vert {E}_{s o l} ( \vec{k} ) \vert}^{2} / {I}_{sat}} ) = exp ( \frac{{g}_{0}}{1 + {I}_{S I D} ( \vec{k} ) / {I}_{sat}} )$$
where:
T_{SLM}(\vec{k}) is a linear transformation that represents the amplitude transmittances at the SLM;
\vec{k} is the position at the SLM plane;
Iₛₐₜ is the saturation intensity;
g₀ is the linear gain at very low intensities, set by a pumping strength;
E(\vec{k}) is an electric field on the SLM;
I_{SID}(\vec{k})=|Eₛₒₗ(\vec{k})|² is the scattered intensity distribution on the SLM.

13. The system according to claim 9, wherein the object's SID and the object's reconstructed image comprise data from a field selected from: astronomy, X-ray, crystallography, imaging though turbid media, short pulse characterization, speech processing, encryption and decryption, ptychographic imaging, lens-less photography and microscopy, NMR, and synthetic aperture radar.

14. The system according to claim 9, wherein the system comprises a single second lens, at least six beam folding elements, and a first polarization beam splitter (PBS₁); all arranged in a ring configuration of a first- and a second-four-focal telescopes, and wherein the second lens serves for both telescopes via the first PBS₁ and wherein the SLM is reflective.

15. The system according to claim 14, further comprises at least one of: a Faraday rotator and at least one half wave plate, configured to rotate their passing beams, such that they enable the first PBS₁ to pass through beams of the first telescope path and to reflect and redirect beams of the second telescope.

16. The system according to claim 14, further comprises a second beam splitter (PBS₂), which is located between the second lens and the reflective SLM, configured to redirect a small part of its received beam, for monitoring and/or imaging purposes, while the substantial part of the beam continues its original path.

17. The system according to claim 16, further comprises a camera and optimally at least one lens, configured to photocopy and/or display the reconstructed image provided by the second PBS₂.

18. A method for reconstructing an image of an object from an input comprising: the object's scattered intensity distribution (SID) and the object's compact support, using the laser system according to claim 9; the method comprising:
spontaneously lasing multiple transverse mode beams, via the gain;
iteratively lasing the beams between the gain and the SLM via the mask, while decaying lasing modes which do not comply with the object's SID and the objects compact support, until only beams with one lasing mode and optionally its conjugating lasing mode are left, thereby the one (or two) mode is most probable as an origin mode;
providing the object's reconstructed image at least at the mask's aperture, based on the most probable mode/s.

19. The method according to claim 18, wherein at least one of the following holds true:
the method further comprising retrieving phase of the most probable lasing mode;
the method further comprising monitoring the gain's reflected images via an output coupler;
the method further comprising displaying the reconstructed image via a camera.
